(19) United States
(12) Patent Application Publication
(10) Pub. No.: US 2007/0099582 A1
(43) Pub. Date: May 3, 2007

(54) METHOD AND APPARATUS FOR SIGNAL DEMODULATION AND TRANSMISSION

(75) Inventors: Min Chen, Irvine, CA (US); Wing Han She, Irvine, CA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: MEDIATEK INC., Hsin-Chu (TW)

(21) Appl. No.: 11/531,331

(22) Filed: Sep. 13, 2006

Related U.S. Application Data
(60) Provisional application No. 60/731,697, filed on Oct. 31, 2005.

(51) Int. Cl. H04B 1/38; H04B 1/40

(52) U.S. Cl. 455/76; 455/73

(57) ABSTRACT

A transceiver comprises a transmitter and a receiver, Dual-band radio signals are simultaneously supported by the transceiver. First and second RF signals are down converted to an intermediate signal based on a first oscillation signal. The intermediate signal is then down converted to an inphase baseband signal and a quadrature baseband signal based on a second oscillation signal. A synthesizer is provided, generating the first and second oscillation signals from one oscillation reference signal. Each of the first and second oscillation signals comprises an inphase part and a quadradure part, and the first frequency is subsequently twice the second frequency. The first frequency is the frequency of first oscillation signal plus the frequency of the second oscillation signal, and the second frequency is difference of the frequency of the first oscillation signal and the frequency of the second oscillation signal.

### CROSS REFERENCE TO RELATED APPLICATIONS

This application claims the benefit of U.S. Provisional Application No. 60/1731697, filed Oct. 31, 2005.

### BACKGROUND OF THE INVENTION

1. Field of the Invention

The invention relates to dual-band transceivers, and in particular, to a synthesizer supporting dual frequency bands for a transceiver.

2. Description of the Related Art

FIG. 1 shows a conventional dual-band transceiver. As known, IEEE 802.11 a standard utilizes 5 GHz band whereas IEEE 802.11 b/g utilize 2.4 GHz band. The transceiver may be inside a WLAN device supporting multiple modes and standards. In FIG. 1, the 5 G demodulator 102a, 2.4 G demodulator 102b and common IF demodulator 104 form a dual-band receiver. The 5 G demodulator 102a and 2.4 G demodulator 102b individually receive an RF signal RFₐ of 5 GHz and an RF signal RF_{b} of 2.4 GHz, and demodulate them into intermediate signal IFₐ and intermediate signal IF_{b} along two different RF paths IFₐ and IF_{b} can be signals with a common intermediate frequency. A 5 G synthesizer 110a and a 2.4 G synthesizer 110b are required for the first demodulation step, each providing oscillation sources of the corresponding RFₐ and RF_{b} frequencies and down-converting the RF signal into the intermediate signal IFₐ and IF_{b} with the same frequency. The common IF synthesizer 120 generates signal for the IF demodulator 104 which demodulates the intermediate signal IFₐ and IF_{b} to baseband, generating an inphase signal BB_{I}, and a quadrature signal BB_{Q}. The baseband signals, BB_{I}, and BB_{Q}, can be either in analog or digital format. The two stage demodulation described may use a super heterodyne architecture. Similarly, for signal transmission, the 5G modulator 112a, 2.4G modulator 112b and IF modulator 114 form a dual-band transmitter which modulates the baseband signals and transmits the first RF signal RFₐ and second RF signal RF_{b}. The same frequency synthesizers as in the receiver can be re-used in the transmitter. Thus a total of three independent synthesizers may be required in a dual band transceiver as shown in FIG. 1.

In this architecture, optional external low-noise amplifiers (LNAs), variable gain amplifiers (VGAs) may have to be used to enhance the receiver sensitivity and power amplifiers (PAs) may have to be used to boost the transmitter output power. Various high-pass, low-pass and polyphase filters may be necessary for channel selection and image rejection. The costs of these components are considerable and known as a design issue. Additionally, implementing multiple synthesizers in a single chip is area-expensive and has potential signal interference problem. Therefore an improvement for dual-band modulation and demodulation is desirable.

### BRIEF SUMMARY OF THE INVENTION

An exemplary embodiment of the transceiver comprises a transmitter and a receiver. The receiver comprises an RF demodulator and an IF demodulator. The RF demodulator is capable of receiving both the first RF signal of a first frequency and the second RF signal of a second frequency individually. The RF demodulator down-converts the first or second RF signal into an intermediate signal utilizing the first oscillation signal. Then the IF demodulator converts the intermediate signal into an inphase baseband signal and a quadrature baseband signal utilizing the second oscillation signal. A synthesizer is provided, generating the first and second oscillation signals from a single oscillation reference signal. Each of the first and second oscillation signals comprises an inphase part and a quadradure part. The first RF frequency is the sum of the frequency of the first oscillation signal and the frequency of the second oscillation signal, and the second RF frequency is the difference of the frequency of the first oscillation signal and the frequency of the second oscillation signal.

The frequency synthesizer may comprise an oscillator, and three dividers. The oscillator generates a reference frequency. The first divider is coupled to the oscillator, receiving the oscillation reference signal and dividing the reference frequency by a first value to generate the first oscillation signal with both the inphase and quadrature oscillation signals LO1_{I} and LO1_{Q}. The inphase divider, coupled to the first divider, receives the inphase part of the first oscillation signal LO1_{I} and divides the frequency thereof by a second value to generate an inphase part of the second oscillation signal LO2_{I}. The quadrature divider, coupled to the first divider, receives the quadrature part of the first oscillation signal LO1_{Q} and divides the frequency thereof by the second value to generate a quadrature part of the second oscillation signal LO2_{Q}. Specifically, the first value is 2 and the second value is 3.

Embodiments of RF and IF demodulators are provided. Additionally, the transmitter in the transceiver comprises an IF modulator and an RF modulator. The IF modulator converts the inphase and quadrature baseband signals to the intermediate signal utilizing the second oscillation signal. The RF modulator, coupled to the IF modulator, up-converts the intermediate signal to the first RF signal or the second RF signal utilizing the first oscillation signal. The first or second RF signal is transmitted after frequency conversion. Various embodiments of the RF modulator and IF modulator are also provided. Furthermore, embodiments of the signal demodulation method, signal transmission method implemented by the transceiver are also provided.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 shows a conventional dual-band transceiver;

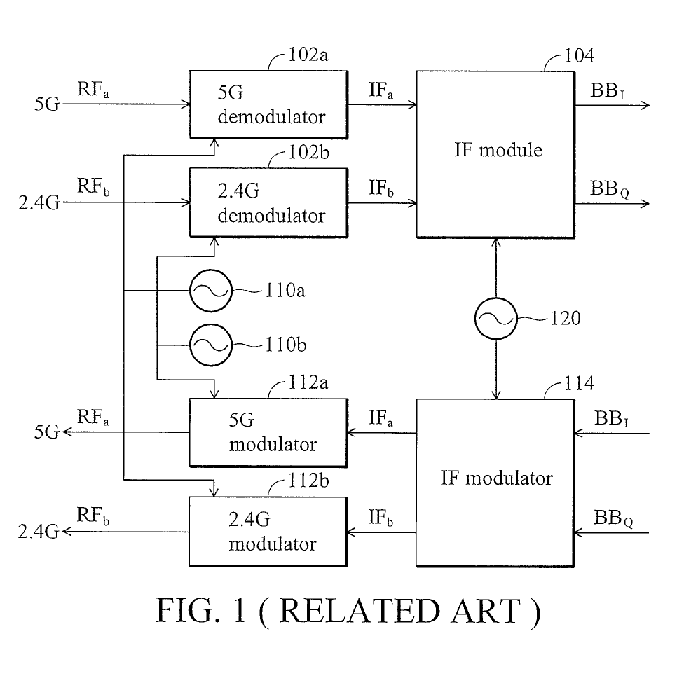

FIG. 2a shows an embodiment of a dual-band transceiver in accordance with the current invention;

FIG. 2b shows an embodiment of a frequency distribution for dual-band demodulation;

FIG. 3 shows an embodiment of synthesizer 202 in FIG. 2a;

FIG. 4a shows an embodiment of a RF demodulator 210 and a IF demodulator 212;

FIG. 4b shows an embodiment of a RF modulator 220 and a IF modulator 222;

FIG. 5a shows another embodiment of the RF modulator 220 and IF modulator 222; and

FIG. 5b shows a further embodiment of the RF modulator 220 and IF modulator 222.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

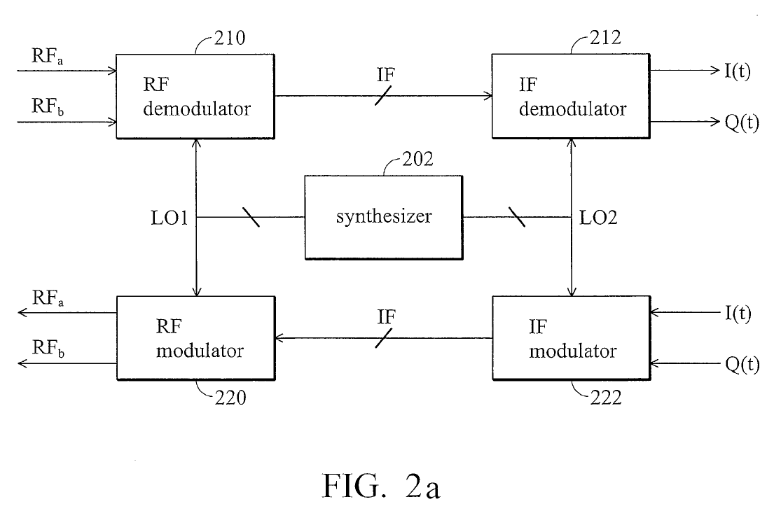

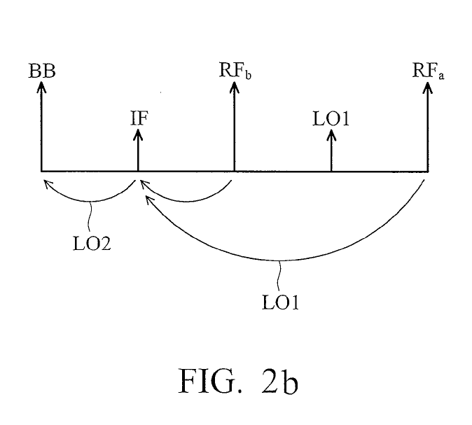

FIG. 2a shows an embodiment of a dual-band transceiver. An RF demodulator 210 receives a first RF signal RFₐ and a second RF signal RF_{b}. When either signal is received, the RF demodulator down-converts the received signal to an intermediate signal IF utilizing a first oscillation signal LO1. The same intermediate IF frequency can be obtained from both RF bands by selecting the frequency of LO1 to be the arithmetic mean of RFₐ and RF_{b}. The IF demodulator 212 then converts the intermediate signal IF to an inphase baseband signal I(t) and a quadrature baseband signal Q(t) utilizing a second oscillation signal LO2. The frequency of LO2 is half of the difference of RFₐ and RFb. The inphase and quadrature baseband signals I(t) and Q(t) are then output in either analog domain for further data conversion or in digital domain for further digital signal processing. In this way, both the RFₐ and RF_{b} signals are down converted to an identical IF and then baseband frequency using common hardware.

A transmitter in the dual-band transceiver comprises an RF modulator 220 and an IF modulator 222, performing signal modulation similar but reversed in function to the demodulation process performed by the RF demodulator 210 and IF demodulator 212. The IF modulator 222 up-converts the inphase baseband transmit signal I(t) and quadrature baseband transmit signal Q(t) to the intermediate signal IF utilizing second oscillation signal LO2. The RF modulator 220, coupled to the IF modulator 222, up-converts the intermediate signal IF to the first RF signal RFₐ or the second RF signal RF_{b} utilizing the first oscillation signal LO1, and the converted first RF signal RFₐ or second RF signal RF_{b} are then transmitted thereby.

FIG. 2b shows an embodiment of frequency distribution for dual-band demodulation. In order to down-convert RFa and RFb to the same intermediate frequency for the subsequent demodulation step, LO1 and LO2 are chosen to have the following relationships with RFa and RFb:
ω_{RFa}=ω_{LO1}+ω_{LO2} (1)
ω_{HFb}=ωLO1−ω_{LO2} (2)
Therefore, ω_{LO1=}(ω_{RFa}+ω_{RFb})/2 (3)
ω_{LO2}=(ω_{RFa}−ωRFb)/2 (4)

In particular, if the first RF signal RFa is twice the second RF signal RFb, such as for the IEEE 802.11a in 5 GHz band and the IEEE 802.11b in 2.4 GHz band , a synthesizer 202 is provided in the embodiment to generate the first oscillation signal LO1 and the second oscillation signal LO2 from a common oscillation reference signal. The frequency of the oscillation reference signal VCO is chosen to be twice ω_{LO1}:
ω_{VCO}2ω_{LO1}= 3/2ω_{RFa} (5)

Frequencies of the first oscillation signal LO1 and second oscillation signal LO2 can be determined to be as follows:
ω_{LO1}=¾ω_{RFa} (6)
ω_{LO2}=¼ω_{RFa} (7)

Based on the formulae, the first oscillation signal LO1 can be derived by dividing the oscillation reference signal VCO by two, and the second oscillation signal LO2 is obtained by dividing the first oscillation signal LO1 by three. Thus, only one oscillation reference signal is required.

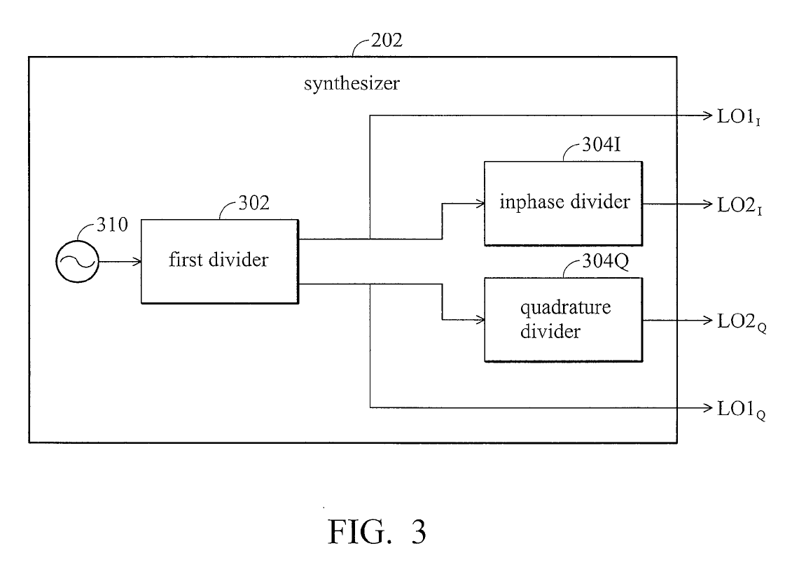

FIG. 3 shows an embodiment of synthesizer 202 in FIG. 2a. The synthesizer 202 comprises an oscillator 310, providing an oscillation reference signal VCO having a frequency of 3/2 of the first RF signal RFₐ. A first divider 302 is coupled to the oscillator 310, dividing the oscillation reference signal VCO by two, such that an inphase part of the first oscillation signal LO1_{I} and a quadrature part of the first oscillation signal LO1_{Q} are generated, having a frequency identical to ¾ of the first RF signal RFₐ. An inphase divider 304I and a quadrature divider 304Q are coupled to the first divider 302, each dividing the inphase and quadrature parts of the first oscillation signal by three to generate inphase and quadrature parts of the second oscillation signal respectively. In this way, only one oscillation reference signal VCO is required to demodulate both 5 GHz and 2.4 GHz signals in a dual-band multi-mode 802.11 a/big transceiver.

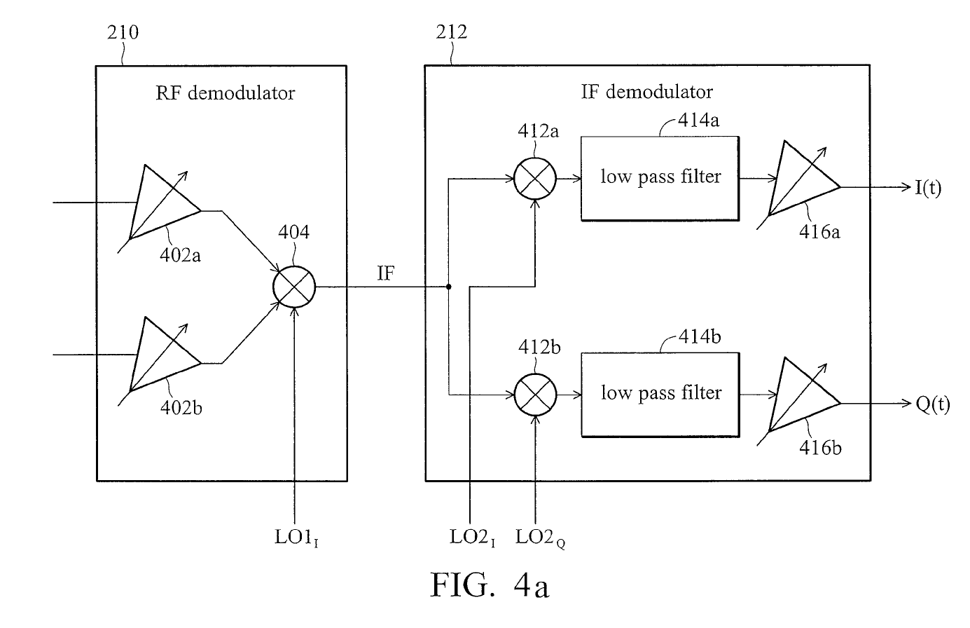

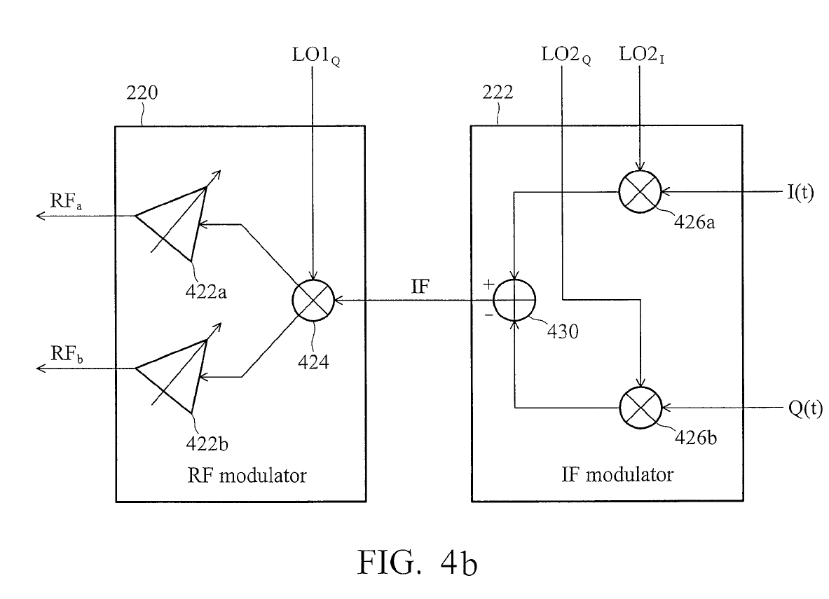

FIG. 4a shows an embodiment of an RF demodulator 210 and an IF demodulator 212. The RF demodulator 210 receives the inphase part of the first oscillation signal LO1_{I} to down convert the first RF signal RFₐ and second RF signal RF_{b} to the intermediate signal IF. RFₐ passes through the first low noise amplifier 402a and RF_{b} passes through the second low noise amplifier 402b respectively before coupling to the common RF mixer 404. The RF mixer utilizes either the inphase part or the quadrature part of the first oscillation signal LO1_{I} to down-convert the first or second RF signals RFₐ and RF_{b} to the intermediate signal IF.

For example, when down converting the first RF signal RFₐ, the following calculations are applicable. The first RF signal RFa can be expressed in the complex form:

$$\begin{matrix}{s}_{RFa} ( t ) = I ( t ) cos ( {ω}_{RFa} t ) - Q ( t ) sin ( {ω}_{RFa} t ) \\ = Re ( {R}_{BB} ( t ) \cdot {ⅇ}^{{jω}_{RFa} t} ) \\ = \frac{1}{2} ( {R}_{BB} ( t ) \cdot {ⅇ}^{j {ω}_{RFa} t} + {R}_{BB}^{*} ( t ) \cdot {ⅇ}^{- j {ω}_{RFa} t} )\end{matrix} \qquad ( 8 )$$

Where I(t) and Q(t) are inphase and quadrature components of the baseband signal R_{BB}(t) being transmitted, and R_{BB}(t)=I(t)+j·Q(t). The first RF signal RFₐ is down converted by the RF demodulator 210, outputting the intermediate signal IF as:

$$\begin{matrix}{S}_{IF} ( t ) = {s}_{RFa} ( t ) ⨯ LO {1}_{I} ( t ) \\ = \frac{1}{2} ( {R}_{BB} ( t ) \cdot {ⅇ}^{j {ω}_{RFa} t} + {R}_{BB}^{*} ( t ) \cdot {ⅇ}^{- j {ω}_{RFa} t} ) \cdot \\ \frac{1}{2} ( {ⅇ}^{j {ω}_{LO 1} t} + {ⅇ}^{- {jω}_{LO 1} t} ) \\ = \frac{1}{4} ( \begin{matrix}{R}_{BB} ( t ) \cdot {ⅇ}^{j ( {ω}_{RFa} + {ω}_{LO 1} ) t} + \\ {R}_{BB}^{*} ( t ) \cdot {ⅇ}^{- j ( {ω}_{RFa} - {ω}_{LO 1} ) t} + \\ {R}_{BB} ( t ) \cdot {ⅇ}^{j ( {ω}_{RFa} - {ω}_{LO 1} ) t} + \\ {R}_{BB}^{*} ( t ) \cdot {ⅇ}^{- j ( {ω}_{RFa} + {ω}_{LO 1} ) t}\end{matrix} ) \\ = \frac{1}{2} ( Re ( {R}_{BB} ( t ) \cdot {ⅇ}^{j ( {ω}_{RFa} + {ω}_{LO 1} ) t} + \\ Re ( {R}_{BB} ( t ) \cdot {ⅇ}^{j ( {ω}_{RFa} - {ω}_{LO 1} ) t} ) )\end{matrix} \qquad ( 9 )$$

The intermediate signal IF is then simultaneously sent to the inphase IF mixer 412a and the quadrature IF mixer 412b. The outputs of the IF mixers 412a and 412b are inphase baseband mixed signal and quadrature baseband mixed signal respectively as explained below. In the inphase IF mixer 412a, the intermediate signal IF is multiplied by the inphase part of the second oscillation signal LO2_{I}:

$$\begin{matrix}{s}_{I} ( t ) = {s}_{IF} ( t ) \cdot cos ( {ω}_{LO 2} t ) \\ = \frac{1}{4} ( \begin{matrix}{R}_{BB} ( t ) \cdot {ⅇ}^{j ( {ω}_{RFa} + {ω}_{LO 1} ) t} + \\ {R}_{BB}^{*} ( t ) \cdot {ⅇ}^{- j ( {ω}_{RFa} - {ω}_{LO 1} ) t} + \\ {R}_{BB} ( t ) \cdot {ⅇ}^{j ( {ω}_{RFa} - {ω}_{LO 1} ) t} + \\ {R}_{BB}^{*} ( t ) \cdot {ⅇ}^{- j ( {ω}_{RFa} + {ω}_{LO 1} ) t}\end{matrix} ) \cdot \frac{1}{2} ( {ⅇ}^{j {ω}_{LO 2} t} + {ⅇ}^{- j {ω}_{LO 2} t} ) \\ = \frac{1}{8} ( \begin{matrix}{R}_{BB} ( t ) \cdot {ⅇ}^{j ( {ω}_{RFa} + {ω}_{LO 1} + {ω}_{LO 2} ) t} + \\ {R}_{BB}^{*} ( t ) \cdot {ⅇ}^{- j ( {ω}_{RFa} - {ω}_{LO 1} - {ω}_{LO 2} ) t} + \\ {R}_{BB} ( t ) \cdot {ⅇ}^{j ( {ω}_{RFa} - {ω}_{LO 1} + {ω}_{LO 2} ) t} + \\ {R}_{BB}^{*} ( t ) \cdot {ⅇ}^{- j ( {ω}_{RFa} + {ω}_{LO 1} - {ω}_{LO 2} ) t}\end{matrix} ) + \\ \frac{1}{8} ( \begin{matrix}{R}_{BB} ( t ) \cdot {ⅇ}^{j ( {ω}_{RFa} + {ω}_{LO 1} - {ω}_{LO 2} ) t} + \\ {R}_{BB}^{*} ( t ) \cdot {ⅇ}^{- j ( {ω}_{RFa} - {ω}_{LO 1} + {ω}_{LO 2} ) t} + \\ {R}_{BB} ( t ) \cdot {ⅇ}^{j ( {ω}_{RFa} - {ω}_{LO 1} - {ω}_{LO 2} ) t} + \\ {R}_{BB}^{*} ( t ) \cdot {ⅇ}^{- j ( {ω}_{RFa} + {ω}_{LO 1} + {ω}_{LO 2} ) t}\end{matrix} ) \\ = \frac{1}{8} ( {R}_{BB} ( t ) + {R}_{BB}^{*} ( t ) ) + ( high frequency terms ) \\ = \frac{I ( t )}{4} + ( high frequency terms )\end{matrix} \qquad ( 10 )$$

Thus, through the first low-pass filter 414a and first variable gain amplifier 416a, the high frequency terms are eliminated, and the I(t) is output as the inphase baseband signal.

Likewise, in the quadrature IF mixer 412b, the intermediate signal IF is mixed with quadrature part of the second oscillation signal LO2_{Q}, generating Q(t)/4 as shown below:

The second low-pass filter 414b and second variable gain amplifier 416b perform filtering and amplifying so that the Q(t) is amplified and output as the quadrature baseband signal.

$$\begin{matrix}{s}_{Q} ( t ) = {s}_{IF} ( t ) \cdot sin ( {ω}_{LO 2} t ) \\ = \frac{1}{4} ( \begin{matrix}{R}_{BB} ( t ) \cdot {ⅇ}^{j ( {ω}_{RF a} + {ω}_{LO 1} ) t} + \\ {R}_{BB}^{*} ( t ) \cdot {ⅇ}^{- j ( {ω}_{RFa} - {ω}_{LO 1} ) t} + \\ {R}_{BB} ( t ) \cdot {ⅇ}^{j ( {ω}_{RFa} - {ω}_{LO 1} ) t} + \\ {R}_{BB}^{*} ( t ) \cdot {ⅇ}^{- j ( {ω}_{RFa} + {ω}_{LO 1} ) t}\end{matrix} ) \cdot \frac{- j}{2} ( {ⅇ}^{j {ω}_{LO 2} t} - {ⅇ}^{- j {ω}_{LO 2} t} ) \\ = \frac{- j}{8} ( \begin{matrix}{R}_{BB} ( t ) \cdot {ⅇ}^{j ( {ω}_{RFa} + {ω}_{LO 1} + {ω}_{LO 2} ) t} + \\ {R}_{BB}^{*} ( t ) \cdot {ⅇ}^{- j ( {ω}_{RFa} - {ω}_{LO 1} - {ω}_{LO 2} ) t} + \\ {R}_{BB} ( t ) \cdot {ⅇ}^{j ( {ω}_{RFa} - {ω}_{LO 1} + {ω}_{LO 2} ) t} + \\ {R}_{BB}^{*} ( t ) \cdot {ⅇ}^{- j ( {ω}_{RFa} + {ω}_{LO 1} - {ω}_{LO 2} ) t}\end{matrix} ) + \\ \frac{- j}{8} ( \begin{matrix}- {R}_{BB} ( t ) \cdot {ⅇ}^{j ( {ω}_{RFa} + {ω}_{LO 1} - {ω}_{LO 2} ) t} - \\ {R}_{BB}^{*} ( t ) \cdot {ⅇ}^{- j ( {ω}_{RFa} - {ω}_{LO 1} + {ω}_{LO 2} ) t} + - \\ {R}_{BB} ( t ) \cdot {ⅇ}^{j ( {ω}_{RFa} - {ω}_{LO 1} - {ω}_{LO 2} ) t} - \\ {R}_{BB}^{*} ( t ) \cdot {ⅇ}^{- j ( {ω}_{RFa} + {ω}_{LO 1} + {ω}_{LO 2} ) t}\end{matrix} ) \\ = \frac{- j}{8} ( - {R}_{BB} ( t ) + {R}_{BB}^{*} ( t ) ) + ( high frequency terms ) \\ = - \frac{Q ( t )}{4} + ( high frequency terms )\end{matrix} \qquad ( 11 )$$

Similarly, for the case of second RF signal RF_{b} represented by:

$$\begin{matrix}{s}_{RFb} ( t ) = I ( t ) cos ( {ω}_{RFb} t ) - Q ( t ) sin ( {ω}_{RFb} t ) \\ = Re ( {R}_{BB} ( t ) \cdot {ⅇ}^{j {ω}_{RFb} t} ) \\ = \frac{1}{2} ( {R}_{BB} ( t ) \cdot {ⅇ}^{j {ω}_{RFb} t} + {R}_{BB}^{*} ( t ) \cdot {ⅇ}^{- j {ω}_{RFb} t} )\end{matrix} \qquad ( 12 )$$

The intermediate signal IF is obtained by multiplying the second RF signal RF_{b} by the inphase part of the first oscillation signal LO1_{I},

$$\begin{matrix}{s}_{IF} ( t ) = {s}_{RFb} ( t ) ⨯ LO {1}_{I} ( t ) \\ = \frac{1}{2} ( {R}_{BB} ( t ) \cdot {ⅇ}^{j {ω}_{RFb} t} + {R}_{BB}^{*} ( t ) \cdot {ⅇ}^{- j {ω}_{RFb} t} ) \cdot \\ \frac{1}{2} ( {ⅇ}^{j {ω}_{LO 1} t} + {ⅇ}^{- j {ω}_{LO 1} t} ) \\ = \frac{1}{4} ( \begin{matrix}{R}_{BB} ( t ) \cdot {ⅇ}^{j ( {ω}_{RFb} + {ω}_{LO 1} ) t} + \\ {R}_{BB}^{*} ( t ) \cdot {ⅇ}^{- j ( {ω}_{RFb} - {ω}_{LO 1} ) t} + \\ {R}_{BB} ( t ) \cdot {ⅇ}^{j ( {ω}_{RFb} - {ω}_{LO 1} ) t} + \\ {R}_{BB}^{*} ( t ) \cdot {ⅇ}^{- j ( {ω}_{RFb} + {ω}_{LO 1} ) t}\end{matrix} ) \\ = \frac{1}{2} ( Re ( {R}_{BB} ( t ) \cdot {ⅇ}^{j ( {ω}_{RFb} + {ω}_{LO 1} ) t} ) + \\ Re ( {R}_{BB} ( t ) \cdot {ⅇ}^{j ( {ω}_{RFb} - {ω}_{LO 1} ) t} ) )\end{matrix} \qquad ( 13 )$$

The inphase IF mixer 412a multiplies the intermediate signal IF with the inphase part of the second oscillation signal LO2_{I}as:

$$\begin{matrix}{s}_{I} ( t ) = {s}_{IF} ( t ) \cdot sin ( {ω}_{LO 2} t ) \\ = \frac{1}{4} ( \begin{matrix}{R}_{BB} ( t ) \cdot {ⅇ}^{j ( {ω}_{RF b} + {ω}_{LO 1} ) t} + \\ {R}_{BB}^{*} ( t ) \cdot {ⅇ}^{- j ( {ω}_{RFa} - {ω}_{LO 1} ) t} + \\ {R}_{BB} ( t ) \cdot {ⅇ}^{j ( {ω}_{RFa} - {ω}_{LO 1} ) t} + \\ {R}_{BB}^{*} ( t ) \cdot {ⅇ}^{- j ( {ω}_{RFa} + {ω}_{LO 1} ) t}\end{matrix} ) \cdot \frac{1}{2} ( {ⅇ}^{j {ω}_{LO 2} t} - {ⅇ}^{- j {ω}_{LO 2} t} ) \\ = \frac{1}{8} ( \begin{matrix}{R}_{BB} ( t ) \cdot {ⅇ}^{j ( {ω}_{RFa} + {ω}_{LO 1} + {ω}_{LO 2} ) t} + \\ {R}_{BB}^{*} ( t ) \cdot {ⅇ}^{- j ( {ω}_{RFa} - {ω}_{LO 1} - {ω}_{LO 2} ) t} + \\ {R}_{BB} ( t ) \cdot {ⅇ}^{j ( {ω}_{RFa} - {ω}_{LO 1} + {ω}_{LO 2} ) t} + \\ {R}_{BB}^{*} ( t ) \cdot {ⅇ}^{- j ( {ω}_{RFa} + {ω}_{LO 1} - {ω}_{LO 2} ) t}\end{matrix} ) + \\ \frac{1}{8} ( \begin{matrix}{R}_{BB} ( t ) \cdot {ⅇ}^{j ( {ω}_{RFa} + {ω}_{LO 1} - {ω}_{LO 2} ) t} + \\ {R}_{BB}^{*} ( t ) \cdot {ⅇ}^{- j ( {ω}_{RFa} - {ω}_{LO 1} + {ω}_{LO 2} ) t} + \\ {R}_{BB} ( t ) \cdot {ⅇ}^{j ( {ω}_{RFa} - {ω}_{LO 1} - {ω}_{LO 2} ) t} + \\ {R}_{BB}^{*} ( t ) \cdot {ⅇ}^{- j ( {ω}_{RFa} + {ω}_{LO 1} + {ω}_{LO 2} ) t}\end{matrix} ) \\ = \frac{1}{8} ( {R}_{BB} ( t ) + {R}_{BB}^{*} ( t ) ) + ( high frequency terms ) \\ = - \frac{I ( t )}{4} + ( high frequency terms )\end{matrix} \qquad ( 14 )$$

After passing through the first low-pass filter 414a and first variable gain amplifier 416a, only I(t) components are output as the inphase baseband signal. Likewise, the quadrature IF mixer 412b multiplies the intermediate signal IF by the quadrature part of the second oscillation signal LO2_{Q} to generate the quadrature baseband signal:

$$\begin{matrix}{s}_{Q} ( t ) = {s}_{IF} ( t ) \cdot sin ( {ω}_{LO 2} t ) \\ = \frac{1}{4} ( \begin{matrix}{R}_{BB} ( t ) \cdot {ⅇ}^{j ( {ω}_{RF b} + {ω}_{LO 1} ) t} + \\ {R}_{BB}^{*} ( t ) \cdot {ⅇ}^{- j ( {ω}_{RFb} - {ω}_{LO 1} ) t} + \\ {R}_{BB} ( t ) \cdot {ⅇ}^{j ( {ω}_{RFb} - {ω}_{LO 1} ) t} + \\ {R}_{BB}^{*} ( t ) \cdot {ⅇ}^{- j ( {ω}_{RFb} + {ω}_{LO 1} ) t}\end{matrix} ) \cdot \frac{- j}{2} ( {ⅇ}^{j {ω}_{LO 2} t} - {ⅇ}^{- j {ω}_{LO 2} t} ) \\ = \frac{- j}{8} ( \begin{matrix}{R}_{BB} ( t ) \cdot {ⅇ}^{j ( {ω}_{RFb} + {ω}_{LO 1} + {ω}_{LO 2} ) t} + \\ {R}_{BB}^{*} ( t ) \cdot {ⅇ}^{- j ( {ω}_{RFb} - {ω}_{LO 1} - {ω}_{LO 2} ) t} + \\ {R}_{BB} ( t ) \cdot {ⅇ}^{j ( {ω}_{RFb} - {ω}_{LO 1} + {ω}_{LO 2} ) t} + \\ {R}_{BB}^{*} ( t ) \cdot {ⅇ}^{- j ( {ω}_{RFb} + {ω}_{LO 1} - {ω}_{LO 2} ) t}\end{matrix} ) + \\ \frac{- j}{8} ( \begin{matrix}{R}_{BB} ( t ) \cdot {ⅇ}^{j ( {ω}_{RFb} + {ω}_{LO 1} - {ω}_{LO 2} ) t} - \\ {R}_{BB}^{*} ( t ) \cdot {ⅇ}^{- j ( {ω}_{RFb} - {ω}_{LO 1} + {ω}_{LO 2} ) t} + - \\ {R}_{BB} ( t ) \cdot {ⅇ}^{j ( {ω}_{RFb} - {ω}_{LO 1} - {ω}_{LO 2} ) t} - \\ {R}_{BB}^{*} ( t ) \cdot {ⅇ}^{- j ( {ω}_{RFb} + {ω}_{LO 1} + {ω}_{LO 2} ) t}\end{matrix} ) \\ = \frac{- j}{8} ( {R}_{BB} ( t ) + {R}_{BB}^{*} ( t ) ) + ( high frequency terms ) \\ = \frac{Q ( t )}{4} + ( high frequency terms )\end{matrix} \qquad ( 15 )$$

The second low-pass filter 414b and second variable gain amplifier 416b amplify the output from quadrature IF mixer 412b to output the Q(t) as the quadrature baseband signal. As described, through carefully chosen first oscillation signal LO1 and second oscillation signal LO2, the first and second RF signals RFₐ and RF_{b} can be down-converted with common RF and IF mixers.

FIG. 4b shows an embodiment of a RF modulator 220 and an IF modulator 222. The inphase baseband transmit signal I(t) and quadrature baseband transmit signal Q(t) are modulated by the first inphase mixer 426a, second inphase mixer 426b and subtractor 430 to form the intermediate signal IF of the form:

$$\begin{matrix}{g}_{IF} ( t ) = I ( t ) cos ( {ω}_{LO 2} t ) - Q ( t ) sin ( {ω}_{LO 2} t ) \\ = Re ( {g}_{BB} ( t ) {ⅇ}^{j {ω}_{LO 2} t} ) \\ = \frac{1}{2} ( {g}_{BB} ( t ) {ⅇ}^{j {ω}_{LO 2} t} + {g}_{BB}^{*} ( t ) {ⅇ}^{- j {ω}_{LO 2} t} )\end{matrix} \qquad ( 16 )$$

wherein the signal I(t)cos(ω_{LO2}t) is a first preliminary intermediate signal, and the signal Q(t) sin(ω_{LO2}t) is a second preliminary intermediate signal.

The RF mixer 424 multiplies the intermediate signal IF by either the inphase or the quadrature part of the first oscillation signal LO1_{I}, to generate a signal comprising both bands. While multiplying the inphase part of the first oscillation signal LO1:

$$\begin{matrix}{g}_{RF} ( t ) = {g}_{IF} ( t ) LO {1}_{I} ( t ) \\ = {g}_{IF} ( t ) cos ( {ω}_{LO 1} t ) \\ = \frac{1}{2} ( {g}_{BB} ( t ) {ⅇ}^{j {ω}_{LO 2} t} + {g}_{BB}^{*} ( t ) {ⅇ}^{- j {ω}_{LO 2} t} ) ⨯ \\ \frac{1}{2} ( {ⅇ}^{j {ω}_{LO 1} t} + {ⅇ}^{- j {ω}_{LO 1} t} ) \\ = \frac{1}{4} ( \begin{matrix}{g}_{BB} ( t ) {ⅇ}^{j ( {ω}_{LO 2} + {ω}_{LO 1} ) t} + \\ {g}_{BB}^{*} ( t ) {ⅇ}^{- j ( {ω}_{LO 2} - {ω}_{LO 1} ) t} + \\ {g}_{BB} ( t ) {ⅇ}^{j ( {ω}_{LO 2} - {ω}_{LO 1} ) t} + \\ {g}_{BB}^{*} ( t ) {ⅇ}^{- j ( {ω}_{LO 2} + {ω}_{LO 1} ) t}\end{matrix} ) \\ = \frac{1}{4} ( {g}_{BB} ( t ) {ⅇ}^{j ( {ω}_{LO 2} + {ω}_{LO 1} ) t} + {g}_{BB}^{*} ( t ) {ⅇ}^{- j ( {ω}_{LO 2} + {ω}_{LO 1} ) t} ) + \\ \frac{1}{4} ( {g}_{BB} ( t ) {ⅇ}^{j ( {ω}_{LO 2} - {ω}_{LO 1} ) t} + {g}_{BB}^{*} ( t ) {ⅇ}^{- j ( {ω}_{LO 2} - {ω}_{LO 1} ) t} ) \\ = \frac{1}{2} Re ( {g}_{BB} ( t ) {ⅇ}^{j {ω}_{RFa} t} ) + \frac{1}{2} Re ( {g}_{BB} ( t ) {ⅇ}^{j {ω}_{Rfb} t} ) \\ = \frac{1}{2} ( I ( t ) cos {ω}_{RFa} t - Q ( t ) sin {ω}_{RFa} t ) + \\ \frac{1}{2} ( I ( t ) cos {ω}_{Rfb} t - Q ( t ) sin {ω}_{RFb} t )\end{matrix} \qquad ( 17 )$$

A selection mechanism may be provided to filter the output from RF mixer 424. For first RF signal RFₐ, components with frequency equal to the sum of first oscillation signal LO1 and second oscillation signal LO2 are selected and output after amplification by the first power amplifier 422a:

$${g}_{RFa} ( t ) = \frac{1}{2} ( I ( t ) cos {ω}_{RFa} t - Q ( t ) sin {ω}_{RF a} t ) \qquad ( 18 )$$

For second RF signal RF_{b}, components with frequency equal to the difference of first oscillation signal LO1 and second oscillation signal LO2 are selected and output after amplification by the second power amplifier 422b:

$${g}_{RFb} ( t ) = \frac{1}{2} ( I ( t ) cos {ω}_{RFb} t - Q ( t ) sin {ω}_{RFb} t ) \qquad ( 19 )$$

Likewise. while multiplying the quadrature part of the first oscillation signal LO1:

$$\begin{matrix}{g}_{RF} ( t ) = {g}_{IF} ( t ) LO {1}_{Q} ( t ) \\ = {g}_{IF} ( t ) sin ( {ω}_{LO 1} t ) \\ = \frac{1}{2} ( {g}_{BB} ( t ) {ⅇ}^{j {ω}_{LO 2} t} + {g}_{BB}^{*} ( t ) {ⅇ}^{0 j {ω}_{LO 2} t} ) ⨯ \\ \frac{1}{2 j} ( {ⅇ}^{j {ω}_{LO 1} t} - {ⅇ}^{- j {ω}_{LO 1} t} ) \\ = \frac{1}{4 j} ( \begin{matrix}{g}_{BB} ( t ) {ⅇ}^{j ( {ω}_{LO 2} + {ω}_{LO 1} ) t} + {g}_{BB}^{*} ( t ) {ⅇ}^{- j ( {ω}_{LO 2} - {ω}_{LO 1} ) t} - \\ {g}_{BB} ( t ) {ⅇ}^{j ( {ω}_{LO 2} - {ω}_{LO 1} ) t} - {g}_{BB}^{*} ( t ) {ⅇ}^{- j ( {ω}_{LO 2} + {ω}_{LO 1} ) t}\end{matrix} ) \\ = \frac{1}{4 j} ( {g}_{BB} ( t ) {ⅇ}^{j ( {ω}_{LO 2} + {ω}_{LO 1} ) t} - {g}_{BB}^{*} ( t ) {ⅇ}^{- j ( {ω}_{LO 2} + {ω}_{LO 1} ) t} ) - \\ \frac{1}{4 j} ( {g}_{BB} ( t ) {ⅇ}^{j ( {ω}_{LO 2} - {ω}_{LO 1} ) t} - {g}_{BB}^{*} ( t ) {ⅇ}^{- j ( {ω}_{LO 2} - {ω}_{LO 1} ) t} ) \\ = \frac{1}{2} Im ( {g}_{BB} ( t ) {ⅇ}^{j {ω}_{RF a} t} ) - \frac{1}{2} Im ( {g}_{BB} ( t ) {ⅇ}^{j {ω}_{RFb} t} ) \\ = \frac{1}{2} ( I ( t ) sin {ω}_{RFa} t - Q ( t ) cos {ω}_{RFa} t ) - \\ \frac{1}{2} ( I ( t ) sin {ω}_{RFb} t - Q ( t ) cos {ω}_{RFb} t ) \\ = {g}_{RFa} ( t ) - {g}_{RFb} ( t )\end{matrix} \qquad ( 20 )$$

In this way, hardware sharing is maximized using the proposed transceiver structure because RF signals from both frequency bands, i.e. the first RF signal RFₐ and the second RF signal RF_{b}, share the same path in transmitter and receiver.

To enhance sideband suppression in the transmitter, single sideband mixers can be used. This is possible because the inphase and quadrature components of the first oscillation signal LO1 and the second oscillation signal LO2 can be conveniently generated from the divide-by-two circuits in frequency synthesizer as illustrated in FIG. 3.

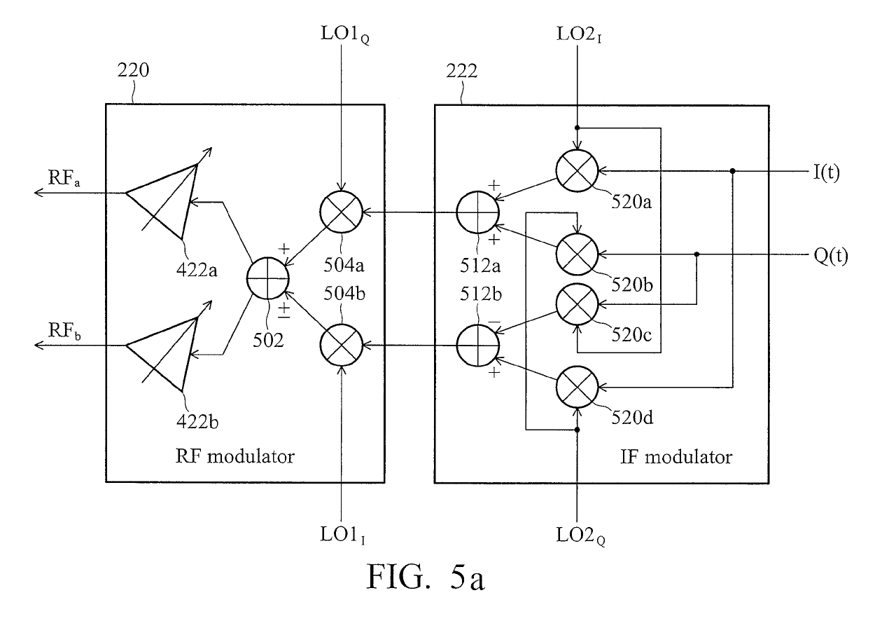

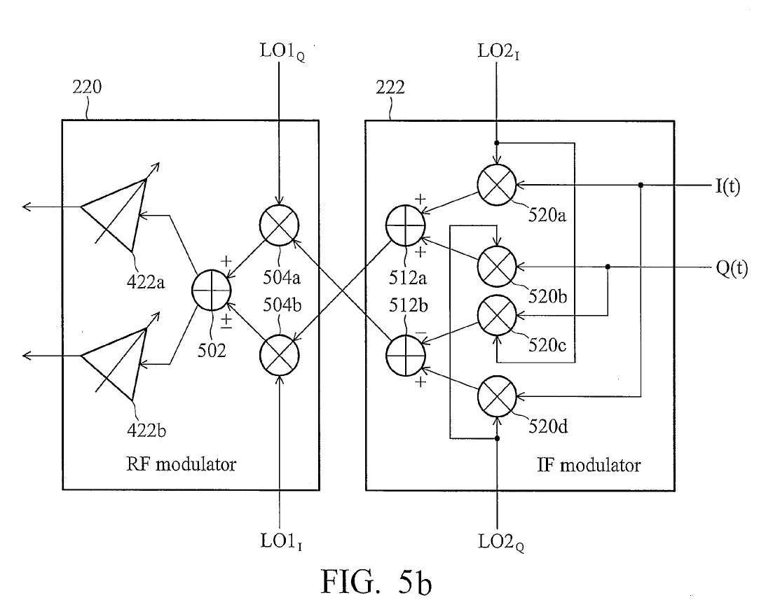

FIG. 5a shows another embodiment of the RF modulator 220 and IF modulator 222 using three single-sideband mixers to enhance sideband suppression. Modifications are made to the transmitter architecture as follows. A baseband transmit signal to be transmitted, comprising inphase signal I(t) and quadrature signal Q(t), is defined as:
g_{BB}(t)=I(t)+jQ(t) (21)

Through modulation performed by the first IF mixer 520a with inphase LO2 signal, the second IF mixer 520b with quadratre LO2 signal, and the first adder 512a, the first preliminary intermediate signal is generated as:

$$\begin{matrix}{g}_{IF 1 ( t )} = I ( t ) cos ( {ω}_{LO 2} t ) + Q ( t ) sin ( {ω}_{LO 2} t ) \\ = Re ( {g}_{BB} ( t ) \cdot {ⅇ}^{- j {ω}_{LO 2} t} ) \\ = \frac{1}{2} ( {g}_{BB} ( t ) \cdot {ⅇ}^{- j {ω}_{LO 2} t} + {g}_{BB}^{*} ( t ) \cdot {ⅇ}^{j {ω}_{LO 2} t} )\end{matrix} \qquad ( 22 )$$

Similarly, the third IF mixer 520c with inphase LO2 signal, the fourth IF mixer 520d with quadrature LO2 signal, and the subtractor 512b generate the second preliminary intermediate signal as:

$$\begin{matrix}{g}_{IF 2} ( t ) = I ( t ) sin ( {ω}_{LO 2} t ) - Q ( t ) cos ( {ω}_{LO 2} t ) \\ = - Im ( {g}_{BB} ( t ) {ⅇ}^{- j {ω}_{LO 2} t} ) \\ = \frac{1}{2 j} ( - {g}_{BB} ( t ) \cdot {ⅇ}^{- j {ω}_{LO 2} t} + {g}_{BB}^{*} ( t ) \cdot {ⅇ}^{j {ω}_{LO 2} t} )\end{matrix} \qquad ( 23 )$$

The first RF mixer 504a then multiplies the first preliminary intermediate signal with the quadrature part of the first oscillation signal LO1_{Q}:

$$\begin{matrix}{g}_{RF 1} ( t ) = {g}_{IF 1} ( t ) \cdot LO {1}_{Q} ( t ) \\ = \frac{1}{2} ( {g}_{BB} ( t ) \cdot {ⅇ}^{- j {ω}_{LO 2} t} + {g}_{BB}^{*} ( t ) \cdot {ⅇ}^{j {ω}_{LO 2} t} ) \cdot \\ \frac{1}{2 j} ( {ⅇ}^{j {ω}_{LO 1} t} - {ⅇ}^{- j {ω}_{LO 1} t} ) \\ = \frac{1}{4 j} ( \begin{matrix}{g}_{BB} ( t ) \cdot {ⅇ}^{j ( {ω}_{LO 1} - {ω}_{LO 2} ) t} + \\ {g}_{BB}^{*} ( t ) \cdot {ⅇ}^{j ( {ω}_{LO 1} + {ω}_{LO 2} ) t} - \\ {g}_{BB} ( t ) \cdot {ⅇ}^{- j ( {ω}_{LO 1} + {ω}_{LO 2} ) t} - \\ {g}_{BB}^{*} ( t ) \cdot {ⅇ}^{- j ( {ω}_{LO 1} - {ω}_{LO 2} ) t}\end{matrix} ) \\ = \frac{1}{2} ( Im ( {g}_{BB} ( t ) \cdot {ⅇ}^{j ( {ω}_{LO 1} - {ω}_{LO 2} ) t} ) + \\ Im ( {g}_{BB}^{*} ( t ) \cdot {ⅇ}^{j ( {ω}_{LO 1} + {ω}_{LO 2} t} ) )\end{matrix} \qquad ( 24 )$$

The second RF mixer 504b multiplies the inphase part of the first oscillation signal LO1_{I}, and second preliminary intermediate signal:

$$\begin{matrix}{g}_{RF 2} ( t ) = {g}_{IF 2} ( t ) \cdot LO {1}_{I} ( t ) \\ = \frac{1}{2 j} ( - {g}_{BB} ( t ) \cdot {ⅇ}^{- j {ω}_{LO 2} t} + {g}_{BB}^{*} ( t ) \cdot {ⅇ}^{j {ω}_{LO 2} t} ) \cdot \\ \frac{1}{2} ( {ⅇ}^{j {ω}_{LO 1} t} + {ⅇ}^{- j {ω}_{LO 1} t} ) \\ = \frac{1}{4 j} ( \begin{matrix}- {g}_{BB} ( t ) \cdot {ⅇ}^{j ( {ω}_{LO 1} - {ω}_{LO 2} ) t} + \\ {g}_{BB}^{*} ( t ) \cdot {ⅇ}^{j ( {ω}_{LO 1} + {ω}_{LO 2} ) t} \\ - {g}_{BB} ( t ) \cdot {ⅇ}^{- j ( {ω}_{LO 1} + {ω}_{LO 2} ) t} + \\ {g}_{BB}^{*} ( t ) \cdot {ⅇ}^{- j ( {ω}_{LO 1} - {ω}_{LO 2} ) t}\end{matrix} ) \\ = \frac{1}{2} ( - Im ( {g}_{BB} ( t ) \cdot {ⅇ}^{j ( {ω}_{LO 1} - {ω}_{LO 2} ) t} ) + \\ Im ( {g}_{BB}^{*} ( t ) \cdot {ⅇ}^{j ( {ω}_{LO 1} + {ω}_{LO 2} ) t} ) )\end{matrix} \qquad ( 25 )$$

The combining unit 502 can generate the second RF signal RF_{b} by subtracting formula (21) from formula (22):

$$\begin{matrix}{g}_{RF} ( t ) = {g}_{RF 1} ( t ) - {g}_{RF 2} ( t ) \\ = \frac{1}{2} ( Im ( {g}_{BB} ( t ) \cdot {ⅇ}^{j ( {ω}_{LO 1} - {ω}_{LO 2} ) t} ) + \\ Im ( {g}_{BB}^{*} ( t ) \cdot {ⅇ}^{j ( {ω}_{LO 1} + {ω}_{LO 2} ) t} ) ) \\ = Im ( {g}_{BB} ( t ) \cdot {ⅇ}^{j ( {ω}_{LO 1} - {ω}_{LO 2} ) t} )\end{matrix} \qquad ( 26 )$$

Therefore, the baseband transmit signal can be up-converted to the lower-band RF signals RF_{b} in this way. On the other hand, the higher-band RF signal RFₐ can be generated in three different ways as described below.

First, the combining unit 502 can generate the first RF signal RFₐ by adding formula (21) and formula (22):

$$\begin{matrix}{g}_{RF} ( t ) = {g}_{RF 1} ( t ) + {g}_{RF 2} ( t ) \\ = \frac{1}{2} ( Im ( {g}_{BB} ( t ) \cdot {ⅇ}^{j ( {ω}_{LO 1} - {ω}_{LO 2} ) t} ) + \\ Im ( {g}_{BB}^{*} ( t ) \cdot {ⅇ}^{j ( {ω}_{LO 1} + {ω}_{LO 2} ) t} ) ) + \\ \frac{1}{2} ( - Im ( {g}_{BB} ( t ) \cdot {ⅇ}^{j ( {ω}_{LO 1} - {ω}_{LO 2} ) t} ) + \\ Im ( {g}_{BB}^{*} ( t ) \cdot {ⅇ}^{j ( {ω}_{LO 1} + {ω}_{LO 2} ) t} ) ) \\ = Im ( {g}_{BB}^{*} ( t ) \cdot {ⅇ}^{j ( {ω}_{LO 1} + {ω}_{LO 2} ) t}\end{matrix} \qquad ( 27 )$$

Second, instead of performing the opposite adding and subtracting operations for the combining unit 502, the IF outputs of adder 512a and subtractor 512b can be swapped to go into the RF mixers 504a and 504b. FIG. 5b shows a further embodiment of the RF modulator 220 and IF modulator 222 to demonstrate this approach. The output of adder 512a is sent to the second RF mixer 504b while the output of subtractor 512b is sent to the first RF mixer 504a. Thus, the first RF mixer 504a up converts the second preliminary intermediate signal by the quadrature part of the first oscillation signal LO1_{Q}:

$$\begin{matrix}{g}_{RF 1} ( t ) = {g}_{IF 2} ( t ) \cdot LO {1}_{Q} ( t ) \\ = \frac{1}{2 j} ( - {g}_{BB} ( t ) \cdot {ⅇ}^{- j {ω}_{LO 2} t} + {g}_{BB}^{*} ( t ) \cdot {ⅇ}^{j {ω}_{LO 2} t} ) \cdot \\ \frac{1}{2 j} ( {ⅇ}^{j {ω}_{LO 1} t} - {ⅇ}^{- {jω}_{LO 1} t} ) \\ = - \frac{1}{4} ( \begin{matrix}- {g}_{BB} ( t ) \cdot {ⅇ}^{j ( {ω}_{LO 1} - {ω}_{LO 2} ) t} + \\ {g}_{BB}^{*} ( t ) \cdot {ⅇ}^{j ( {ω}_{LO 1} + {ω}_{LO 2} ) t} \\ {g}_{BB} ( t ) \cdot {ⅇ}^{- j ( {ω}_{LO 1} + {ω}_{LO 2} ) t} - \\ {g}_{BB}^{*} ( t ) \cdot {ⅇ}^{- j ( {ω}_{LO 1} - {ω}_{LO 2} ) t}\end{matrix} ) \\ = \frac{1}{2} ( Re ( {g}_{BB} ( t ) \cdot {ⅇ}^{j ( {ω}_{LO 1} - {ω}_{LO 2} ) t} ) - \\ Re ( {g}_{BB}^{*} ( t ) \cdot {ⅇ}^{j ( {ω}_{LO 1} + {ω}_{LO 2} ) t} ) )\end{matrix} \qquad ( 28 )$$

The second RF mixer 504b performs the other up conversion likewise:

$$\begin{matrix}{g}_{RF 2} ( t ) = {g}_{IF 1} ( t ) \cdot LO {1}_{I} ( t ) \\ = \frac{1}{2} ( {g}_{BB} ( t ) \cdot {ⅇ}^{- {jω}_{LO 2} t} + {g}_{BB}^{*} ( t ) \cdot {ⅇ}^{{jω}_{LO 2} t} ) \cdot \frac{1}{2} ( {ⅇ}^{{jω}_{LO 1} t} + {ⅇ}^{- {jω}_{LO 1} t} ) \\ = \frac{1}{4} ( \begin{matrix}{g}_{BB} ( t ) \cdot {ⅇ}^{j ( {ω}_{LO 1} - {ω}_{LO 2} ) t} + {g}_{BB}^{*} ( t ) \cdot {ⅇ}^{j ( {ω}_{LO 1} + {ω}_{LO 2} ) t} \\ {g}_{BB} ( t ) \cdot {ⅇ}^{- j ( {ω}_{LO 1} + {ω}_{LO 2} ) t} + {g}_{BB}^{*} ( t ) \cdot {ⅇ}^{- j ( {ω}_{LO 1} - {ω}_{LO 2} ) t}\end{matrix} ) \\ = \frac{1}{2} ( Re ( {g}_{BB} ( t ) \cdot {ⅇ}^{j ( {ω}_{LO 1} - {ω}_{LO 2} ) t} ) + Re ( {g}_{BB}^{*} ( t ) \cdot {ⅇ}^{j ( {ω}_{LO 1} + {ω}_{LO 2} ) t} ) )\end{matrix} \qquad ( 29 )$$

The combining unit 502 then still performs a subtraction of equation (28) by equation (29) to generate first RF signal RFₐ:

$$\begin{matrix}{g}_{RF} ( t ) = {g}_{RF 1} ( t ) - {g}_{RF 2} ( t ) \\ = \frac{1}{2} ( Re ( {g}_{BB} ( t ) \cdot {ⅇ}^{j ( {ω}_{LO 1} - {ω}_{LO 2} ) t} ) - Re ( {g}_{BB}^{*} ( t ) \cdot {ⅇ}^{j ( {ω}_{LO 1} + {ω}_{LO 2} ) t} ) ) - \\ \frac{1}{2} ( Re ( {g}_{BB} ( t ) \cdot {ⅇ}^{j ( {ω}_{LO 1} - {ω}_{LO 2} ) t} ) + Re ( {g}_{BB}^{*} ( t ) \cdot {ⅇ}^{j ( {ω}_{LO 1} + {ω}_{LO 2} ) t} ) ) \\ = - Re ( {g}_{BB}^{*} ( t ) \cdot {ⅇ}^{j ( {ω}_{LO 1} + {ω}_{LO 2} ) t} )\end{matrix} \qquad ( 30 )$$

Transmit baseband signals I(t) and Q(t) are therefore up-converted to higher frequency first RF signal RFₐ.

For the third way to generate RFₐ, if the inphase and quadrature parts of the first oscillation signal sent to the first RF mixer 504a and second RF mixer 504b in FIG. 5a are swapped, the same result can be derived as shown in the formulae (29) and (30).

In summary, a sliding IF dual-band transceiver architecture is proposed. The usage of sum and difference of the first and second oscillation signals LO1 and LO2 effectively maximizes hardware sharing by allowing the signals for two different frequency bands to pass through the same signal path. When the first RF is twice the second RF, only one frequency synthesizer is required to generate local oscillation signals for the two frequency conversion stages and the two frequency bands Additionally, the transmitter architecture utilizing single sideband mixers enhances sideband suppression.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A transceiver, comprising:
an R-F demodulator, capable of receiving a first RF signal of a first frequency and a second RF signal of a second frequency, and selectively down converting the first or the second RF signal to an intermediate signal utilizing a first oscillation signal;
an IF demodulator, down converting the intermediate signal to an inphase baseband signal and a quadrature baseband signal utilizing a second oscillation signal; and
a synthesizer, generating the first and second oscillation signals from an oscillation reference signal; wherein:
each of the first and second oscillation signals comprises an inphase part and a quadradure part;
the first frequency is the sum of the frequency of the first oscillation signal and the second oscillation signal; and
the second frequency is the difference of the frequency of the first oscillation signal and the second oscillation signal.

2. The transceiver as claimed in claim 1, wherein the first frequency is twice of the second frequency.

3. The transceiver as claimed in claim 1, wherein the synthesizer comprises:
an oscillator, generating the oscillation reference signal of a reference frequency;
a first divider, coupled to the oscillator, receiving the oscillation reference signal and dividing the source frequency by a first value to generate the first oscillation signal;
an inphase divider, coupled to the first divider, receiving the inphase part of the first oscillation signal and dividing the frequency thereof by a second value to generate an inphase part of the second oscillation signal; and
a quadrature divider, coupled to the first divider, receiving the quadrature part of the first oscillation signal and dividing the frequency thereof by the second value to generate a quadrature part of the second oscillation signal.

4. The transceiver as claimed in claim 3, wherein the first value is 2 and the second value is 3.

5. The transceiver as claimed in claim 3, wherein the RF demodulator comprises:
a first low noise amplifier, receiving and amplifying the first RF signal to generate a first amplified RF signal,
a second low noise amplifier, receiving and amplifying the second RF signal to generate a second amplified RF signal;
an RP mixer, coupled to the first and second low noise amplifiers, selectively mixing the first amplified RF or the second amplified RF signals to the intermediate signal utilizing the inphase part of the first oscillation signal.

6. The transceiver as claimed in claim 3, wherein the IF demodulator comprises:
an inphase IF mixer, receiving the inphase part of the second oscillation signal to mix the intermediate signal IF into an inphase baseband mixed signal;
a quadrature IF mixer, receiving the quadrature part of the second oscillation signal to mix the intermediate signal IF into a quadrature baseband mixed signal;
a first low-pass filter, coupled to the inphase IF mixer, filtering the inphase baseband mixed signal to generate a inphase baseband signal;
a second low-pass filter, coupled to the quadrature IF mixer, filtering the quadrature baseband mixed signal to generate a quadrature baseband signal.

7. The transceiver as claimed in claim 3, further comprising:
an IF modulator, up converting the inphase and quadrature baseband transmit signals to the intermediate signal utilizing the second oscillation signal; and
an RF modulator, coupled to the IF modulator, selectively up converting the intermediate signal to either the first RF signal or the second RF signal utilizing the first oscillation signal, and transmitting the first or second RF signal

8. The transceiver as claimed in claim 7, wherein the IF modulator comprises:
a first inphase mixer, receiving the inphase part of the second-oscillation signal to mix the inphase baseband transmit signal to a first preliminary intermediate signal,
a second inphase mixer, receiving the quadrature part of the second oscillation signal to mix the quadrature baseband transmit signal to a second preliminary intermediate signal; and
a subtractor, obtaining the difference of the first and second preliminary intermediate signals to generate the intermediate signal.

9. The transceiver as claimed in claim 8, wherein the RF modulator comprises:
an RF mixer, receiving either the inphase or quadrature part of the first oscillation signal and the intermediate signal, and selectively mixing the intermediate signal to a first RF mixed signal or a second RF mixed signal;
a first power amplifier, coupled to the RF mixer, amplifying the first RF mixed signal to generate the first RF signal ; and
a second power amplifier, coupled to the RF mixer, amplifying the second RF mixed signal to generate the second RF signal.

10. The transceiver as claimed in claim 7, wherein the IF modulator comprises:
a first inphase IF mixer, mixing the inphase baseband transmit signal utilizing the inphase part of the second oscillation signal;
a second inphase IF mixer, mixing the quadrature baseband transmit signal utilizing the quadrature part of the second oscillation signal;
a first quadrature IF mixer, mixing the inphase baseband transmit signal utilizing the quadrature part of the second oscillation signal;
a second quadrature IF mixer, mixing the quadrature baseband transmit signal utilizing the inphase part of the second oscillation signal;
an adder, coupled to the first and second inphase IF mixers, adding the mixing results therefrom to generate a first preliminary intermediate signal; and
a subtractor, coupled to the first and second quadrature IF mixers, generating a second preliminary intermediate signal by obtaining the difference of the outputs of first quadrature IF mixer and second quadrature IF mixer.

11. The transceiver as claimed in claim 10, wherein the RF modulator comprises:
a first RF mixer, mixing the first preliminary intermediate signal utilizing quadrature part of the first oscillation signal;
a second RF mixer, mixing the second preliminary intermediate signal utilizing inphase part of the first oscillation signal;
a combining unit, selectively adding the outputs from the first and second RE mixers to generate a first combined signal, or obtaining the difference of the outputs of the first and second RF mixers to generate a second combined signal;
a first power amplifier, coupled to the combining unit, amplifying the first combined signal to generate the first RF signal , and
a second power amplifier, coupled to the combining unit, amplifying the second combined signal to generate the second RF signal .

12. The transceiver as claimed in claim 10, wherein the RF modulator comprises:
a first RF mixer, mixing the second preliminary intermediate signal utilizing quadrature part of the first oscillation signal;
a second RF mixer, mixing the first preliminary intermediate signal utilizing inphase part of the first oscillation signal;
a combining unit, selectively obtaining the difference of the outputs of the first and second RF mixers to generate a first combined signal, or adding the outputs from the first and second RF mixers to generate a second combined signal;
a first power amplifier, coupled to the combining unit, amplifying the first combined signal to generate the first RF signal; and
a second power amplifier, coupled to the combining unit, amplifying the second combined signal to generate the second RF signal

13. A signal demodulation method, selectively demodulating a first RF signal of a first frequency or a second RF signal of a second frequency based on one oscillation source, comprising:
generating first and second oscillation signals based on the oscillation reference signal;
selectively down converting the first or second RF signal to an intermediate signal based on the first oscillation signal; and
down converting the intermediate signal to an inphase baseband signal and a quadrature baseband signal based on the second oscillation signal; wherein:
the first frequency is sum of the frequency of the first oscillation signal and he second oscillation signal; and
the second frequency is difference of the frequency of the first oscillation signal and the second oscillation signal.

14. The signal demodulation method as claimed in claim 13, wherein the generation of the first and second oscillation signals comprises:
generating the oscillation reference signal having a reference frequency,
dividing the reference frequency by a first value to generate the first oscillation signal comprising an inphase part and a quadrature part;
dividing the inphase part of the first oscillation signal by a second value to generate an inphase part of the second oscillation signal, and
dividing the quadrature part of the first oscillation signal by the second value to generate a quadrature part of the second oscillation signal.

15. The signal demodulation method as claimed in claim 14, wherein the first frequency is twice of the second frequency.

16. The signal demodulation method as claimed in claim 14, wherein the first value is 2 and the second value is 3.

17. The signal demodulation method as claimed in claim 14, wherein the down conversion of the first or the second RF signals comprises conversion of the first or the second RF signals to the intermediate signal based on the inphase part of the first oscillation signal.

18. The signal demodulation method as claimed in claim 14, wherein the down conversion of the intermediate signal comprises:
multiplying the intermediate signal IF by the inphase part of the second oscillation signal to generate the inphase baseband mixed signal,
multiplying the intermediate signal IF by the quadrature part of the second oscillation signal to generate the quadrature baseband mixed signal;
filtering the inphase baseband mixed signal to generate the inphase baseband signal; and
filtering the quadrature baseband mixed signal to generate the quadrature baseband signal.

19. A signal transmission method, modulating an inphase and a quadrature baseband signal into a first RF signal of a first frequency or a second RF signal of a second frequency with one oscillation source, comprising:
generating a first and a second oscillation signals based on the oscillation reference signal;
up converting the inphase and quadrature baseband transmit signals to an intermediate signal based on the second oscillation signal, and
selectively up converting the intermediate signal to the first RF signal or the second RF signal based on the first oscillation signal, and transmitting the converted first or second RF signal, wherein:
the first frequency is sum of the frequency of the first oscillation signal and the second oscillation signal; and
the second frequency is difference of the frequency of the first oscillation signal and the second oscillation signal.

20. The signal transmission method as claimed in claim 19, wherein the generation of the first and second oscillation signals comprises:
generating the oscillation reference signal having a reference frequency,
dividing the reference frequency by a first value to generate the first oscillation signal comprising an inphase part and a quadrature part;
dividing the inphase part of the first oscillation signal by a second value to generate an inphase part of the second oscillation signal; and
dividing the quadrature part of the first oscillation signal by the second value to generate a quadrature part of the second oscillation signal.

21. The signal transmission method as claimed in claim 20, wherein the first value is 2 and the second value is 3.

22. The signal transmission method as claimed in claim 20, wherein the generation of the intermediate signal comprises:
multiplying the inphase part of the second oscillation signal by the inphase baseband transmit signal to generate a first preliminary intermediate signal;
multiplying the quadrature part of the second oscillation signal by the quadrature baseband transmit signal to generate a second preliminary intermediate signal, and
obtaining the difference of the first and second preliminary intermediate signals to obtain the intermediate signal.

23. The signal transmission method as claimed in claim 20, wherein the generation of the first and second RF signals comprises:
multiplying the inphase or quadrature part of the first oscillation signal by the intermediate signal to generate a mixed RF signal, and
filtering the mixed RF signal to select the corresponding component of the mixed RF signal as the first or the second RF signal.

24. The signal transmission method as claimed in claim 20, wherein generation of the intermediate signal comprises:
(a) multiplying the inphase transmit baseband signal by the inphase part of the second oscillation signal;
(b) multiplying the quadrature transmit baseband signal by the quadrature part of the second oscillation signal;
(c) multiplying the inphase transmit baseband signal by the quadrature part of the second oscillation signal;
(d) multiplying the quadrature transmit baseband signal by the inphase part of the second oscillation signal;
adding the results of steps (a) and (b) to generate a first preliminary intermediate signal; and
subtracting one of the results of step (d) and step (c) by the other to generate a second preliminary intermediate signal.

25. The signal transmission method as claimed in claim 24, wherein the generation of the first and second RF signals comprises:
(e) multiplying the first preliminary intermediate signal by the quadrature part of the first oscillation signal;
(f) multiplying the second preliminary intermediate signal by the inphase part of the first oscillation signal;
adding the results from steps (e) and (f) to generate the first RF signal, and
calculating the difference of the results of step (e) and step (f) to generate the second RF signal.

26. The signal transmission method as claimed in claim 24, wherein the generation of the first and second RF signals comprises:
(e) multiplying the first preliminary intermediate signal by the inphase part of the first oscillation signal,
(f) multiplying the second preliminary intermediate signal by the quadrature part of the first oscillation signal;
adding the results from steps (e) and (f) to generate the second RF signal, and
calculating the difference of the results of step (e) and step (f) to generate the first RF signal.
